(19) United States
(12) Patent Application Publication
(10) Pub. No.: US 2015/0184729 A1
(43) Pub. Date: Jul. 2, 2015

(54) BALL SCREW CAPABLE OF SENSING PUSH FORCE IN REAL TIME

(71) Applicant: National Chung Cheng University, Chia-Yi County (TW)

(72) Inventors: Yeau-Ren JENG, Tainan City (TW); Yu-Xian HUANG, Tainan City (TW)

(73) Assignee: National Chung Cheng University, Chia-Yi County (TW)

(21) Appl. No.: 14/146,574

(22) Filed: Jan. 2, 2014

(51) Int. Cl. F16H 25/22; F16H 57/04; G01L 5/00

(52) U.S. Cl. CPC F16H 25/2214; G01L 5/0071; F16H 57/0497

(57) ABSTRACT

A ball screw capable of sensing a push force in real time is formed of a screw rod, a screw nut mounted to the screw rod, a plurality of balls mounted between the screw rod and the screw nut, and a force sensor having a first fixture portion and a second fixture portion. The first and second fixture portions are fixed to a working bench and the screw nut, respectively, for making the force sensor sense how much the push force is while the screw nut drives the working bench to move. In this way, monitoring the voltage value outputted from the force sensor can monitor the push force in real time while the ball is working.

### BACKGROUND OF THE INVENTION

1. Field of the Invention

The present invention relates generally to a ball screw and more particularly, to a ball screw capable of sensing a push force in real time.

2. Description of the Related Art

A ball screw is a common component in precision positioning and keeps rolling to serve as the power transmission interface between the screw rod and the screw nut for much reduction of frictional resistance generated while the screw nut is working. However, in the process of processing a workpiece, different sizes of the workpieces lead to different push forces applied to the screw nut. For example, if the workpiece is too heavy, enormous push force will be generated while the screw nut is moving; meanwhile, if there is none of any immediate lubrication, the wear and tear will happen between the screw nut and the screw rod to further make the preload gradually disappear, thus reducing the positioning accuracy.

Taiwan Patent Pub. No. 1407026 disclosed a method diagnostic of preload ineffectiveness of a ball screw and a device based on the method, in which a voiceprint signal generated while the ball screw is working can be filtered by empirical mode decomposition (EMD), then processed by Hilbert-Huang transform (HHT) to generate Hilbert-Huang spectrum (HHS), next processed by multi-scale entropy extraction to generate multi-scale entropy complexity mode, and after the raw multi-scale entropy complexity mode and the current multi-scale entropy complexity mode are compared, whether a preload of the ball screw disappears or not can be effectively diagnosed for the user to monitor the ball screw. However, in the process of measurement based on this method, the measuring accuracy may be adversely affected easily subject to other environmental factors, such as vibration, noise, or frequency. In other words, this method fails to provide accurate measuring outcome for the preload of the ball screw.

Taiwan Patent Pub. No. 587542 disclosed a force sensor for an ejection screw of an injection molding machine, in which a load cell is fixedly mounted to a fastening plate after injection, and a ball guide screw nut is fixedly mounted to the load cell. In fact, the ball guide screw nut does not contact the fastening plate after injection, so all of the axial force can be applied to the load cell, while injection or measurement proceeds, to lessen distortion of the pressure signal as it may happen. In addition, when the load cell is put on the ball guide screw nut and an injection servomotor outputs to drive rotation of the ball guide screw, the load cell can receive the signal and react immediately to enhance the response rate. However, the connection relationship among the load cell, the fastening plate before injection, the fastening plate after injection, and the screw nut is complicated, and the load cell is not located at the forced center of the screw nut or where the force is applied equably. In this way, measured push force or pressure may be inaccurate to further lead to measuring error.

### SUMMARY OF THE INVENTION

The primary objective of the present invention is to provide a ball screw capable of sensing a push force in real time while the ball screw is working.

The foregoing objective of the present invention is attained by the ball screw formed of a screw rod, a screw nut, a plurality of balls, and a force sensor. The screw rod includes an external thread. The screw nut is sleeved onto the screw rod and includes an internal circulatory passage and an internal thread. A spiral passage is formed between the internal and external threads and linked with the internal circulatory passage to further form a load path therebetween. The balls keep running within the load path. The force sensor includes a first fixture portion and a second fixture portion opposite to the first fixture portion. The first and second fixture portions are fixed to a working bench and the screw nut, respectively, for making the force sensor sense how much the push force is, while the screw nut drives the working bench to move, for the user's real-time surveillance.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a partially sectional view of the preferred embodiment of the present invention.

FIG. 4 is a partially side view of the preferred embodiment of the present invention.

FIG. 5 is a block diagram of two elements of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

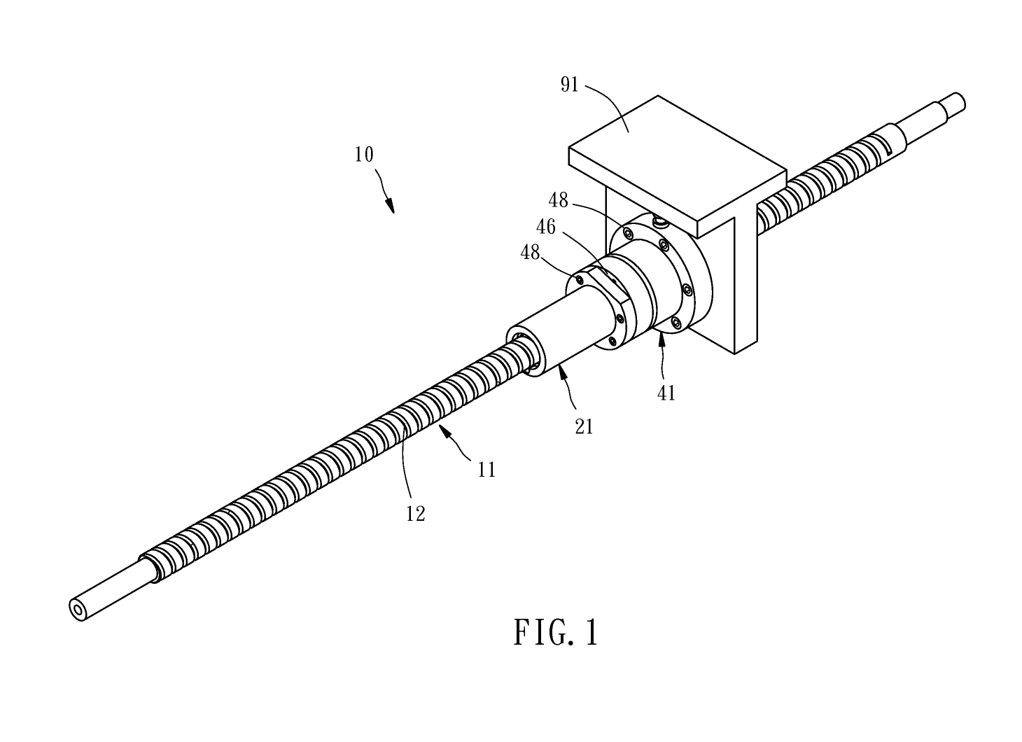

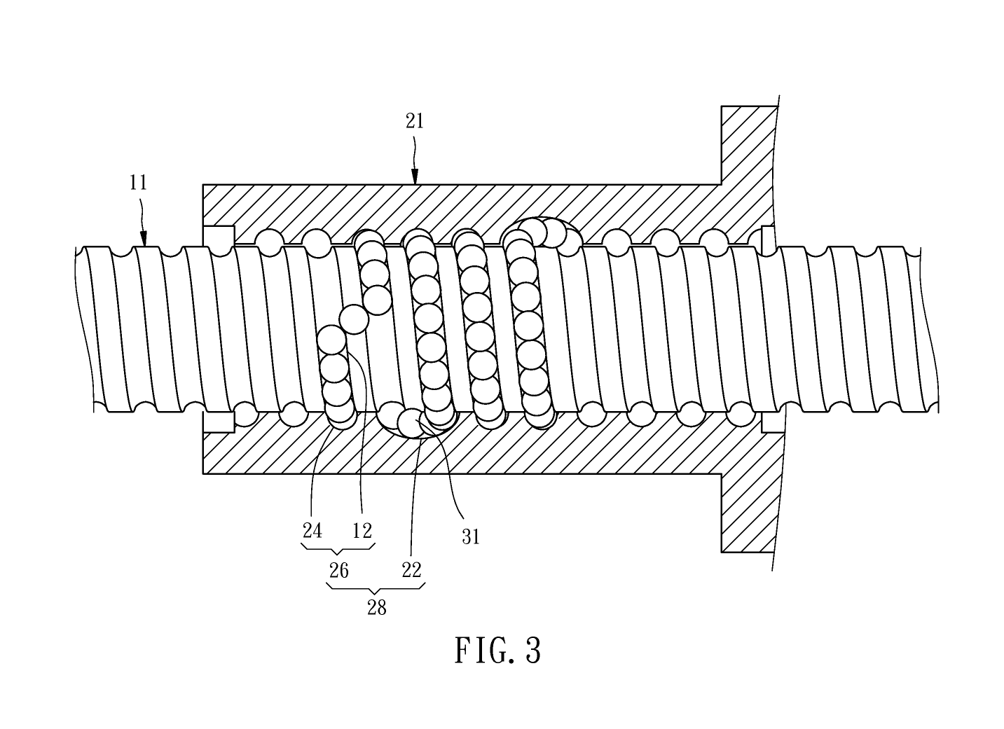

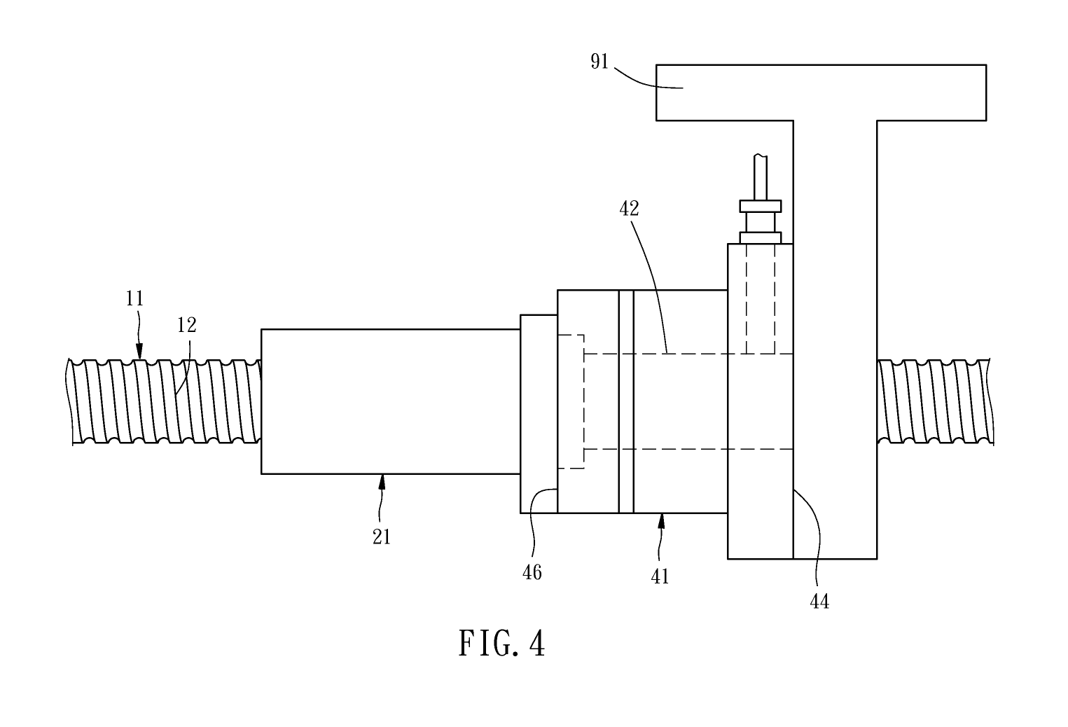

Referring to FIG. 1, a ball screw 10 constructed according to a preferred embodiment of the present invention is to drive a working bench 91 to move. Referring to FIGS. 3 and 4, the ball screw 10 is formed of a screw rod 11, a screw nut 21, a plurality of balls 31, and a force sensor 41. The detailed descriptions and operations of these elements as well as their interrelations are recited in the respective paragraphs as follows.

The screw rod 11 is inserted through the working bench 91 and includes an external thread 12.

The screw nut 21 is screwed with the screw rod 11 and includes an internal circulatory passage 22 and an internal thread 24. As shown in FIG. 3, a spiral passage 26 is formed between the external and internal threads 12 and 24 and linked with the internal circulatory passage 22, so in this way, a load path 28 is formed between the spiral passage 26 and the internal circulatory passage 22.

The balls 31 are mounted within the load path 28 for reducing frictional resistance against the screw nut 21 while the screw nut 21 is working relative to the screw rod 11.

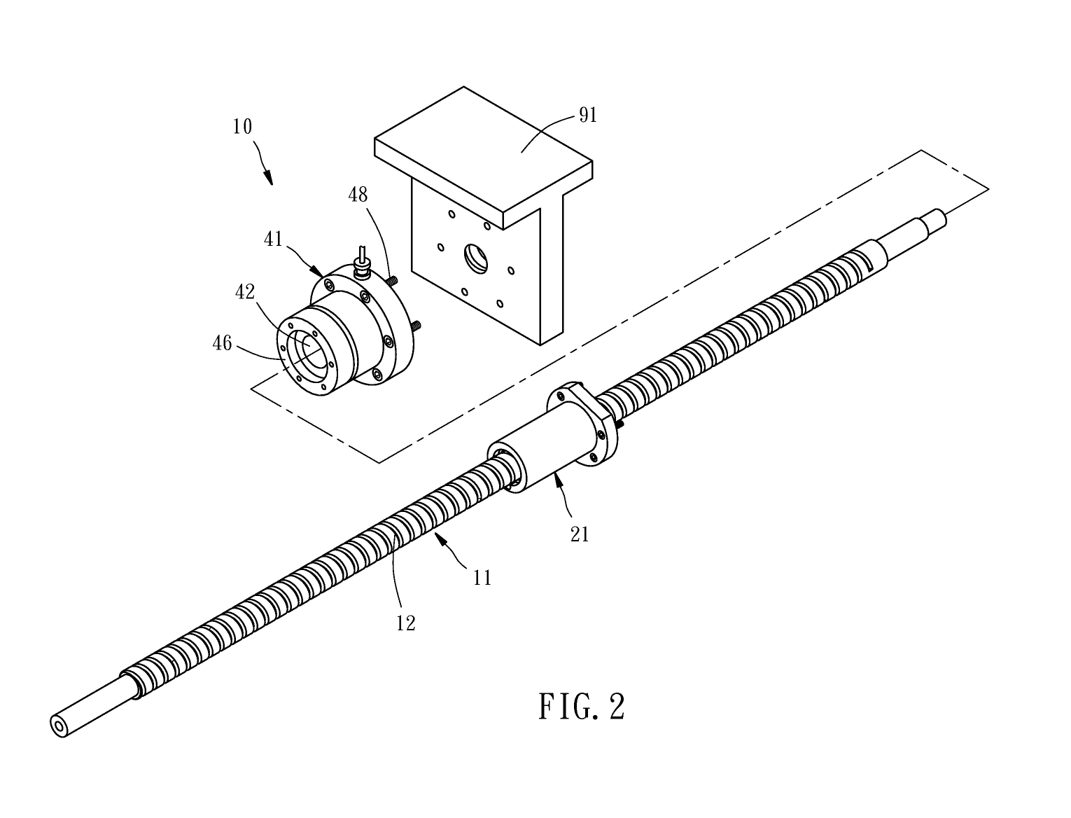

The force sensor 41 includes a through hole 42 for the screw rod 11 to be inserted through. The through hole 42 has a diameter larger than an external diameter of the screw rod 11, as shown in FIGS. 2 and 4, to disable the screw rod 11 from substantial contact with the force sensor 41 after the screw rod 11 is inserted through the through hole 42. The force sensor 41 includes a first fixture portion 44 and a second fixture portion 46 opposite and parallel to the first fixture portion 44. The first and second fixture portions 44 and 46 are fixedly mounted to the working bench 91 and the screw nut 21 via a plurality of screw bolts 48, as shown in FIG. 1, so the force sensor 41 is located between the working bench 91 and the screw nut 21.

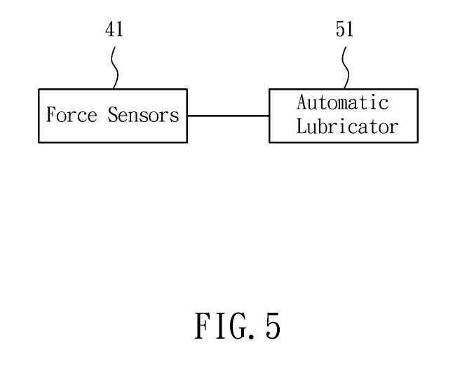

In actual operation, as shown in FIG. 3, the screw nut 21 can be axially moved along the screw rod 11 subject to the rotation of the screw rod 11. In the process of the movement, the force sensor 41 can drive the working bench 91 to move altogether. Under the circumstances, the push force applied to the screw nut 21 is variable subject to the size of a workpiece put on the working bench 91 and meanwhile, the force sensor 41 can output voltage value corresponding to the change of the push force. In light of the outputted voltage value, it can be converted as to whether the push force is normal or not while the screw nut 21 is working. Referring to FIG. 5, to supply lubricating oil to the screw nut 21, the force sensor 41 can be electrically connected with an automatic lubricator 51. The automatic lubricator 51 can identify whether it is necessary to supply any lubricating oil to the screw nut 21 pursuant to the amount of the push force sensed by the force sensor 41. As soon as the push force becomes overgreat, the screw nut 21 will be supplied with the lubricating oil to prolong the service life of the ball screw 10.

In conclusion, the ball screw 10 can monitor the voltage value outputted from the force sensor 41 to not only monitor the push force applied to the screw rod 11 at work in real time but securely keep normal preload to further have superior rigidity, positioning precision, and positioning stability.

What is claimed is:

1. A ball screw capable of sensing a push force in real time, comprising:
a screw rod having an external thread;
a screw nut sleeved onto the screw rod and having an internal circulatory passage, and an internal thread, a spiral passage being formed between the internal and external threads and linked with the internal circulatory passage to form a load path with the internal circulatory passage,
a plurality of balls running within the load path; and
a force sensor having a first fixture portion and a second fixture portion opposite to the first fixture portion, the first and second fixture portions being fixed to a working bench and the screw nut, the force sensor having a through hole for the screw nut to be inserted through, the through hole having a diameter larger than an external diameter of the screw rod to disable the screw rod from contact with the force sensor.

2. The ball screw as defined in claim 1, wherein the first and second fixture portions are parallel to each other.

3. The ball screw as defined in claim 1, wherein the force sensor is electrically connected with an automatic lubricator, the automatic lubricator being capable of lubricating the screw nut according to a push force sensed by the force sensor.
